(19) United States
(12) Patent Application Publication
(10) Pub. No.: US 2026/0105371 A1
(43) Pub. Date: Apr. 16, 2026

(54) TASK PREDICTION MODEL TRAINING METHOD, MAINTENANCE TASK DETERMINATION METHOD, DEVICE AND STORAGE MEDIUM

(71) Applicants: GUANGDONG POWER GRID CO., LTD., Guangdong (CN); Dongguan Power Supply Bureau of Guangdong Power Grid Co., Ltd., Dongguan City (CN)

(72) Inventors: Weijian LAI, Guangdong (CN); Shoubin CHEN, Guangdong (CN); Anping HUANG, Guangdong (CN); Runfeng HU, Guangdong (CN); Zejian QIU, Guangdong (CN); Xinlei CAI, Guangdong (CN); Hebin JIANG, Guangdong (CN); Shuan LIU, Guangdong (CN); Jingguang LI, Guangdong (CN); Jiahui CHEN, Guangdong (CN)

(73) Assignees: GUANGDONG POWER GRID CO., LTD., Guangdong (CN); Dongguan Power Supply Bureau of Guangdong Power Grid Co., Ltd., Dongguan City (CN)

(21) Appl. No.: 19/349,327

(22) Filed: Oct. 3, 2025

(30) Foreign Application Priority Data
Oct. 12, 2024 (CN) 202411420829.7

(51) Int. Cl. G06N 20/00

(52) U.S. Cl. CPC G06N 20/00

(57) ABSTRACT

A task prediction model training method includes: when a maintenance task is performed in a power grid, collecting, for the power grid, system running data and operational data of the maintenance task; performing a simulation of the maintenance task for the power grid to expand the operational data under a variety of the system running data; if the expanding is completed, performing pre-processing and feature data extraction on the system running data and the operational data; annotating the feature data with label data based on a maintenance result of the simulation of the maintenance task; and under supervision of the label data, training a preset deep learning model to be a task prediction model based on the feature data. A maintenance task determination method is executed based on the trained task prediction model. A device and a storage medium are also disclosed. Thereby improving the efficiency of power grid maintenance.

### CROSS-REFERENCE TO RELATED APPLICATIONS

This application claims priority to Chinese Patent Application No. 202411420829.7, filed on Oct. 12, 2024, which is hereby incorporated by reference in its entirety.

### TECHNICAL FIELD

Embodiments of the present application relate to the technical field of big data analysis, and in particular, to a task prediction model training method, a maintenance task determination method, a device and a storage medium.

### BACKGROUND

With the long-term operation of the power grid, electrical devices such as transformers, transmission lines, and switch cabinets will gradually age and pose a risk of failure.

At present, for the electrical devices in the power grid, maintenance plans are developed mainly relying on technical personnel based on operational specifications and personal experience, to evaluate and maintain the electrical devices by performing maintenance to the electrical devices, timely detect and repair potential faults of the electrical devices, for reducing power outages caused by sudden failures of the electrical devices.

However, there is a high degree of subjectivity in operational specifications and personal experience, which can easily lead to errors and omissions in maintenance when facing complex and changeable power grid environments, resulting in lower efficiency of maintenance.

### SUMMARY

The present application provides a task prediction model training method, a maintenance task determination method, a device and a storage medium, to improve the efficiency of power grid maintenance.

In a first aspect, an embodiment of the present application provides a task prediction model training method, including:
when a maintenance task is performed in a power grid, collecting, for the power grid, system running data and operational data of the maintenance task;
performing a simulation of the maintenance task for the power grid, to expand the operational data under a variety of the system running data;
in a case the expanding is completed, performing pre-processing on the system running data and the operational data;
in a case the pre-processing is completed, extracting feature data from the system running data and the operational data;
annotating the feature data with label data based on a maintenance result of the simulation of the maintenance task; and
under supervision of the label data, training a preset deep learning model to be a task prediction model based on the feature data.

In a second aspect, an embodiment of the present application also provides a maintenance task determination method, including:
when waiting for performing a maintenance task in a power grid, collecting, for the power grid, system running data and operational data of the maintenance task;
performing pre-processing on the system running data and the operational data;
in a case the pre-processing is completed, extracting feature data from the system running data and the operational data;
loading a task prediction model trained by the method according to the task prediction model training method as described in the first aspect; and
inputting the feature data into the task prediction model, to obtain an execution result of the maintenance task.

In a third aspect, an embodiment of the present application also provides a task prediction model training apparatus, including:
a data collecting module, configured to: when a maintenance task is performed in a power grid, collect, for the power grid, system running data and operational data of the maintenance task;
a data expanding module, configured to: perform a simulation of the maintenance task for the power grid, to expand the operational data under a variety of the system running data;
a pre-processing module, configured to: in a case the expanding is completed, perform pre-processing on the system running data and the operational data;
a feature extracting module, configured to: in a case the pre-processing is completed, extract feature data from the system running data and the operational data;
a label annotating module, configured to: annotate the feature data with label data based on a maintenance result of the simulation of the maintenance task; and
a model training module, configured to: under supervision of the label data, train a preset deep learning model to be a task prediction model based on the feature data.

In a fourth aspect, an embodiment of the present application also provides a maintenance task determination apparatus, including:
a power grid data collecting module, configured to: when waiting for performing a maintenance task in a power grid, collect, for the power grid, system running data and operational data of the maintenance task;
a data pre-processing module, configured to: perform pre-processing on the system running data and the operational data;
a system data feature extracting module, configured to: in a case the pre-processing is completed, extract feature data from the system running data and the operational data;
a model loading module, configured to: load the task prediction model trained by the task prediction model training method provided in the first aspect; and
an execution result acquiring module, configured to: input the feature data into the task prediction model, to obtain an execution result of the maintenance task.

In a fifth aspect, an embodiment of the present application also provides a computer device, including:
one or more processors;
a storage apparatus, configured to store one or more programs;
when the one or more programs are executed by the one or more processors, the one or more processors are caused to implement the task prediction model training method provided in the first aspect of the present application, or the maintenance task determination method provided in the second aspect of the present application.

In a sixth aspect, an embodiment of the present application also provides a non-transitory computer readable storage medium, storing a computer program, where when the program is executed by a processor, the task prediction model training method provided in the first aspect of the present application is implemented, or, the maintenance task determination method provided in the second aspect of the present application is implemented.

In a seventh aspect, an embodiment of the present application also provides a computer program product, where the computer program product includes a computer program, when the computer program is executed by a processor, the task prediction model training method provided in the first aspect of the present application is implemented, or, the maintenance task determination method provided in the second aspect of the present application is implemented.

In the embodiments of the present application, when a maintenance task is performed in a power grid, system running data and operational data of the maintenance task are collected for the power grid; a simulation of the maintenance task for the power grid is performed to expand the operational data under a variety of the system running data; if the expanding is completed, pre-processing is performed on the system running data and the operational data; if the pre-processing is completed, feature data is extracted from the system running data and the operational data; the feature data is annotated with label data based on a maintenance result of the simulation of the maintenance task; and under supervision of the label data, a preset deep learning model is trained to be a task prediction model based on the feature data. Collecting and expanding operational data assists in gaining a more comprehensive understanding of the performance of maintenance tasks in the power grid under different operating conditions, thereby improving the generalization ability of the model. Secondly, the extraction of feature data and annotation of label data provide a high-quality training foundation for a deep learning model. On the other hand, when waiting for performing a maintenance task in a power grid, system running data and operational data of the maintenance task are collected for the power grid; pre-processing and feature data extraction are performed on the system running data and the operational data; the trained task prediction model is loaded; the feature data is input into the task prediction model, to obtain an execution result of the maintenance task. By performing the pre-processing and the feature data extraction on the system running data and the operational data collected for the power grid, scientific basis can be provided for decision-making; the feature data is input into the trained task prediction model and the execution result of the maintenance task is obtained, thereby optimizing resource allocation, enhancing safety and reducing costs, and improving the efficiency of power grid maintenance.

### BRIEF DESCRIPTION OF DRAWINGS

FIG. 1 is a flowchart of a task prediction model training method provided in a first embodiment of the present application.

FIG. 2 is a block diagram of data collected in a simulated power grid provided in the first embodiment of the present application.

FIG. 3 is a block diagram of maintenance result data of a simulated power grid provided in the first embodiment of the present application.

FIG. 4 is a flowchart of a maintenance task determination method provided in a second embodiment of the present application.

FIG. 5 is a structure block diagram of a task prediction model training apparatus provided in a third embodiment of the present application.

FIG. 6 is a structure block diagram of a maintenance task determination apparatus provided in a fourth embodiment of the present application.

FIG. 7 is a schematic structure diagram of a computer device provided in a fifth embodiment of the present application.

### DESCRIPTION OF EMBODIMENTS

In order to make the solution of the present application more understandable for those skilled in the art, the following will provide a clear and comprehensive description of the technical solution in the embodiments of the present application in conjunction with the accompanying drawings of the embodiments of the present application. Obviously, the described embodiments are a part of the embodiments of the present application, not all of them. Based on the embodiments of the present application, all other embodiments obtained by those of ordinary skill in the art without any creative effort should be within the protection scope of the present application.

It should be noted that, terms “first” and “second” used in the description, claims, and drawings of the present application are used to distinguish similar objects, rather than describing a specific order or sequence. It should be understood that the terms used in this way can be interchanged in an appropriate circumstance, so that the embodiments of the present application described herein can cover embodiments which are implemented in orders other than those illustrated or described herein. In addition, terms “including” and “having”, as well as any variants thereof, are intended to cover non-exclusive inclusions. For example, a process, a method, a system, a product, or a device that includes a series of steps or units is not limited to the clearly listed steps or units, but may optionally include steps or units that are not clearly listed, or may optionally include other steps or units that inherent to the process, the method, the product, or the device.

### First Embodiment

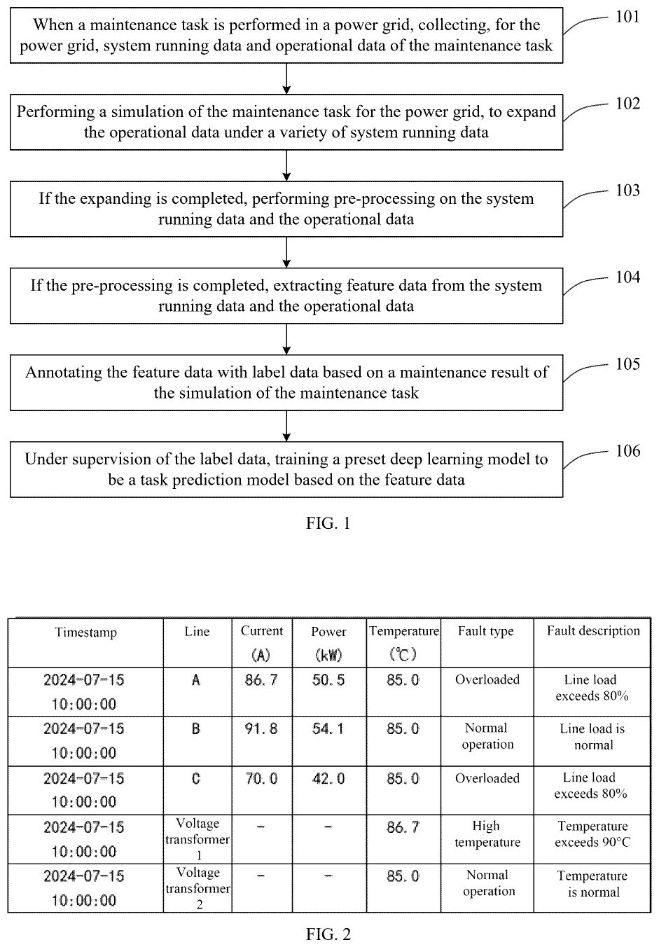

Referring to FIG. 1, it shows a flowchart of a task prediction model training method provided in the first embodiment of the present application. The method can be executed by a task prediction model training apparatus. The task prediction model training apparatus may be implemented in the form of hardware and/or software, and the task prediction model training apparatus can be configured in a computer device. As shown in FIG. 1, the method includes:
a step 101, when a maintenance task is performed in a power grid, collecting, for the power grid, system running data and operational data of the maintenance task.

Maintenance tasks are usually performed for the power grid under circumstances such as regular maintenance, troubleshooting, equipment upgrades, seasonal preparations, and safety inspections. These maintenance tasks are usually assigned to professional operation and maintenance teams or external contractors, who are responsible for specific maintenance and repair work to ensure the normal operation of power grid equipment and the reliability of system.

In this embodiment, when a maintenance task is performed in the power grid, system running data and operational data of the maintenance task of an automatic scheduling system and an automatic power distribution system in the power grid are collected. The system running data includes power system topology, equipment parameters, line parameters, loading data, etc., to assist in monitoring the performance and health status of the power grid, timely detecting abnormal situations, and ensuring the safety and stability of the system. The operational data of the maintenance task includes maintenance plan time, power outage equipment, safety measures, power supply conversion plan, reclosing enable/disable operation plan, operational tasks and operating equipment, etc., recording specific measures and results during the maintenance process. The collected system running data and operational data of the maintenance task are historical and real data, these data corresponds to an already executed maintenance task and is mainly used for training a deep learning model.

A step 102, performing a simulation of the maintenance task for the power grid, to expand the operational data under a variety of system running data.

Simulation refers to simulating the behavior and characteristics of real systems or processes through establishing models and utilizing computer technology, in order to analyze their running status and prediction results, and evaluate their performance in different scenarios. The present application aims to solve problems of insufficient processing of various system running data and imperfect methods of generating data for training the deep learning model in the existing art. It adopts simulation technology to simulate various power grid running scenarios, in order to expand the running data of the power grid running scenarios and the operational data under the running data, and conduct subsequent training for the deep learning model to improve the accuracy of the deep learning model.

In this embodiment, when a maintenance task is performed in a power grid, by simulating different system running data and matching the operational data of the maintenance task with the system running data, the performance of the power grid in various scenarios and execution results of maintenance tasks can be comprehensively evaluated. Potential issues are identified in advance, operational data of maintenance tasks is expanded, risks during actual maintenance task execution processes are reduced, and the safety and reliability of the system(s) are enhanced.

In an embodiment of the present application, the step 102 may include following steps.

A step 1021, formulating one or more simulation rules for the power grid according to a knowledge graph of the maintenance task.

The knowledge graph is a structured data model that organizes and represents information in the form of nodes and edges, and it is used for describing entities and their interrelationships. In the execution of maintenance tasks in the power grid, the knowledge graph can integrate various related data, such as equipment characteristics, fault modes, maintenance history, and operating procedures, to form a comprehensive knowledge system.

In this embodiment, each of the simulation rules is formulated for the power grid according to the knowledge graph of scheduling the maintenance task and the actual business needs. A systematic set of rules is constructed utilizing existing maintenance knowledge, experience, and data relationships, to guide the simulation process and parameter settings, improve the accuracy and effectiveness of the simulation model, and enable the simulation model to truly reflect the performance of the power grid in different maintenance task scenarios. Each of the one or more simulation rules includes a condition, a data source and operational steps.

A step 1022, calling a preset rule engine to perform the simulation of the maintenance task for the power grid based on the one or more simulation rules, to obtain the operational data under a variety of the system running data.

The rule engine (for example, Drools, etc.) is a software system, used for executing predefined rules and logic, to handle complex data and decision-making processes.

In this embodiment, during the simulated execution of the maintenance task on the power grid, the rule engine generates a variety of system running data through simulation according to the simulation rules, generates matching operational data for the variety of simulated system running data by simulating execution of maintenance tasks on the power grid. By using these simulation rules, the rule engine can quickly identify problems, optimize decision-making, and generate corresponding operational recommendations, to ensure the safety and reliability of the power grid in different scenarios.

Specifically, as shown in FIG. 2, running of the power grid is simulated in the preset rule engine and real-time data streams are integrated, which ensures that a corresponding operation is quickly executed when a load condition or a temperature condition reaches a threshold, and system running data is collected from devices on lines at the same timestamp. In FIG. 2, each row represents the system running data of each device at this timestamp, including current, power, temperature, fault type, and fault description of the device. Respective simulation rules are loaded, and when it is detected, in the preset rule engine, that the system running data meets a condition, target data is read from the system running data according to the data source, and an operation is performed by substituting the target data into the operational step, to obtain the operational data under a variety of system running data. Every time an update to the system running data is detected, the rule engine is triggered to execute the simulation rule(s) and automatically generate the operational data under the system running data.

For example, based on load data and equipment status in history, simulation software (MATLAB/Simulink) is utilized to simulate operational data in a circumstance of high load and high temperature. Taking the high load period of the power grid (such as the high temperature period in summer) as an example, the power grid equipment faces significant pressure and requires effective load management measures to ensure the safety of equipment and the stability of power supply. The following are predefined simulation rules, which will not be limited by the present application herein.

Rule one executes a load splitting operation.

Condition: if a load of a line exceeds 80%, the load splitting operation needs to be executed.

Data source: monitored real-time load data which records current and power of respective lines.

Operational steps: monitor load data of lines. When the load exceeds 80%, trigger the rule of load splitting to transfer part of load to a backup line, to ensure that the load of a main line is reduced to a safe level.

Rule two executes a device cooling operation.

Condition: if a temperature of a device exceeds 90%, the device cooling operation needs to be executed.

Data source: device temperature sensor data.

Operational steps: monitor the device temperature in real time. When the temperature exceeds 90%, trigger the cooling operation. Start a cooling system to lower the device temperature, and continuously monitor until it returns to normal.

A step 1023, performing a data augmentation operation on the operational data, to expand the operational data.

In this embodiment, the data augmentation operation is performed on the operational data which is obtained by simulation. Data augmentation techniques include adding noise, random scaling and cropping, rotating, flipping, color transformation (such as adjusting brightness and contrast degree), time shifting, data synthesis (using a generative adversarial network), and simulation parameter perturbations. Using the data augmentation techniques can increase the diversity of operational data and achieve the purpose of expanding operational data.

A step 103, if the expanding is completed, performing pre-processing on the system running data and the operational data.

In this embodiment, after the operational data is expanded, corresponding pre-processing operations can be respectively performed on the system running data and the operational data, to improve the quality of the system running data and the operational data.

For example, the pre-processing on the system running data may include following steps.

A step 1031, using a linear interpolation method to fill in missing values for the system running data.

In this embodiment, the linear interpolation method is a commonly used technique for filling missing values, suitable for time series data or continuous data. When processing the system running data, the linear interpolation method estimates unrecorded system running data by utilizing the linear relationship among the system running data recorded at certain times, the formula is as follows:

$${x}_{i} = \frac{{x}_{i - 1} + {x}_{i + 1}}{2} .$$

In the formula, xᵢ represents the unrecorded system running data, xᵢ₋₁ and xᵢ₊₁ represent adjacent system running data that are recorded at certain times.

A step 1032, if the missing values are filled, using a wavelet transform algorithm to remove noise from the system running data.

In this embodiment, the wavelet transform is an effective signal processing technique suitable for analyzing signals with non-stationary characteristics, especially time series data. Because the wavelet transform can decompose signals into different frequency components and is suitable for processing system running data containing sudden changes or outliers, it is commonly used to remove short-term burst noise. After the missing values are filled, the application of the wavelet transform algorithm can decompose the system running data into components of different frequencies, thereby distinguishing useful signals from noise, effectively suppressing noise while preserving the main characteristics of the signals. The adopted formula is as follows:

$${x}^{′} = {\sum }_{k = - ∞}^{∞} < x , {φ}_{j , k} > {φ}_{j , k} .$$

In the formula, x′ represents the signal of the system running data whose noise had been removed, x represents the original signal of the system running data, φ_{j,k} represents a wavelet basis function, k represents a shifted parameter of the wavelet basis function.

A step 1033, if the noise is removed, performing Gaussian filtering processing on the system running data.

In this embodiment, if the noise is removed from the system running data, Gaussian filtering processing is performed on the system running data. Gaussian filtering is usually used to smooth signals and remove high-frequency noise, and is suitable for processing continuous and stable data. Gaussian filter is particularly useful for system running data of power grid equipment (such as temperature, pressure, and other sensor data), because Gaussian filter can smooth measured system running data and reduce high-frequency noise caused by sensor jitter or small fluctuations. The adopted formula is as follows:

$${y}^{′} = y * g .$$

In the formula, y′ represents the signal of the system running data after being filtered, y represents the original signal of the system running data, * represents a convolution operation, g represents a Gaussian kernel function.

For example, the pre-processing on the operational data may include following steps.

A step 1034, using a linear interpolation method to fill in missing values for the operational data.

In this embodiment, when processing the operational data, the linear interpolation method estimates unrecorded operational data by utilizing the linear relationship among the operational data recorded at certain times, the formula is as follows:

$${x}_{i} = \frac{{x}_{i - 1} + {x}_{i + 1}}{2} .$$

In the formula, xᵢ represents the unrecorded operational data, xᵢ₋₁ and xᵢ₊₁ represent adjacent operational data recorded at certain times.

A step 1035, if the missing values are filled, using a wavelet transform algorithm to remove noise from the operational data.

In this embodiment, after the missing values are filled, the application of the wavelet transform algorithm can decompose the operational data into components of different frequencies, thereby distinguishing useful signals from noise, which can effectively suppress noise while preserving the main characteristics of the signals. The adopted formula is as follows:

$${x}^{′} = {\sum }_{k = - ∞}^{∞} < x , {φ}_{j , k} > {φ}_{j , k} .$$

In the formula, x′ represents the signal of the operational data whose noise had been removed, x represents the original signal of the operational data, φ_{j,k} represents a wavelet basis function, k represents a shifted parameter of the wavelet basis function.

A step 1036, if the noise is removed, performing Gaussian filtering processing on the operational data.

In this embodiment, if the noise is removed from the operational data, Gaussian filtering processing is performed on the operational data, which can smooth the operational data and reduce high-frequency noise caused by sensor jitter or small fluctuations. The adopted formula is as follows:

$${y}^{′} = y * g .$$

In the formula, y′ represents the signal of the operational data after being filtered, y represents the original signal of the operational data, * represents a convolution operation, g represents a Gaussian kernel function.

A step 104, if the pre-processing is completed, extracting feature data from the system running data and the operational data.

In this embodiment, after the data pre-processing is completed, feature data can be extracted respectively from the system running data and the operational data to improve the effectiveness of training the deep learning model. Through feature extraction, the dimensionality of the system running data and the operational data can be reduced, the effectiveness of training the deep learning model can be improved, and at the same time, the interpretability of the system running data and the operational data can be enhanced, thereby reducing the impact of noise.

For example, by using a min-max scaling method to perform a normalization operation separately on the system running data and the operational data, the dimensional influence between different features can be effectively eliminated, the training of the deep learning model can be more stable and efficient. In addition, by processing of special situations, such as when a maximum value is equal to a minimum value, the correctness of the processing of the system running data and the operational data can be ensured.

The min-max scaling method is used to perform the normalization operation on the system running data, the formula is as follows:

$${x}^{′} = \frac{x - min ( x )}{max ( x ) - min ( x )} .$$

In the formula, x represents the system running data, x′ represent the system running data after being normalized, max(x) represents a maximum value of the system running data, min(x) represents a minimum value of the system running data.

The min-max scaling method is used to perform the normalization operation on the operational data, the formula is as follows:

$${x}^{′} = \frac{x - min ( x )}{max ( x ) - min ( x )} .$$

In the formula, x represents the operational data, x′ represents the operational data after being normalized, max(x) represents a maximum value of the operational data, min(x) represents a minimum value of the operational data.

In this embodiment, if the normalization operation of the system running data and the operational data is completed, a least absolute shrinkage and selection operator (LASSO) is used to extract feature data from the system running data and the operational data, then the extracted feature data are spliced.

The least absolute shrinkage and selection operator (LASSO) is used to extract feature data from the system running data, and the formula is as follows:

$$min ( \frac{1}{2 n} {\sum }_{i = 1}^{n} {( {y}_{i} - {x}_{i} w )}^{2} + λ ‖ w ‖ ) .$$

In the formula, n represents the number of the system running data, yᵢ represents an actual output value of the i-th system running data, xᵢ represents a feature vector of the i-th system running data, w represents a weight vector, λ represents a regularized parameter.

The least absolute shrinkage and selection operator (LASSO) is used to extract feature data from the operational data, the formula is as follows:

$$min ( \frac{1}{2 n} {\sum }_{i = 1}^{n} {( {y}_{i} - {x}_{i} w )}^{2} + λ ‖ w ‖ ) .$$

In the formula, n represents the number of the operational data, yᵢ represents an actual output value of the i-th operational data, xᵢ represents a feature vector of the i-th operational data, w represents a weight vector, λ represents a regularized parameter.

The least absolute shrinkage and selection operator (LASSO) can simultaneously perform feature selection and parameter estimation. By introducing λ regularization, LASSO can effectively reduce the complexity of the deep learning model and prevent overfitting. Meanwhile, the normalization operation assists in improving the performance of LASSO, as it ensures that all features are on the same scale, which helps the algorithm to more accurately identify important features, thereby enhancing the interpretability and predictive ability of the deep learning model. Therefore, when processing the system running data and the operational data, applying LASSO after normalization can more effectively extract valuable feature data.

A step 105, annotating the feature data with label data based on a maintenance result of the simulation of the maintenance task.

The label data refers to output information corresponding to feature data in machine learning and data analysis, which is used to represent the category or attribute of a sample. During supervised learning, the label data provides a target value for the deep learning model, to enable it to learn the mapping relationship from an input feature to an output result, in order to provide a clear objective for the model training and optimize the model training.

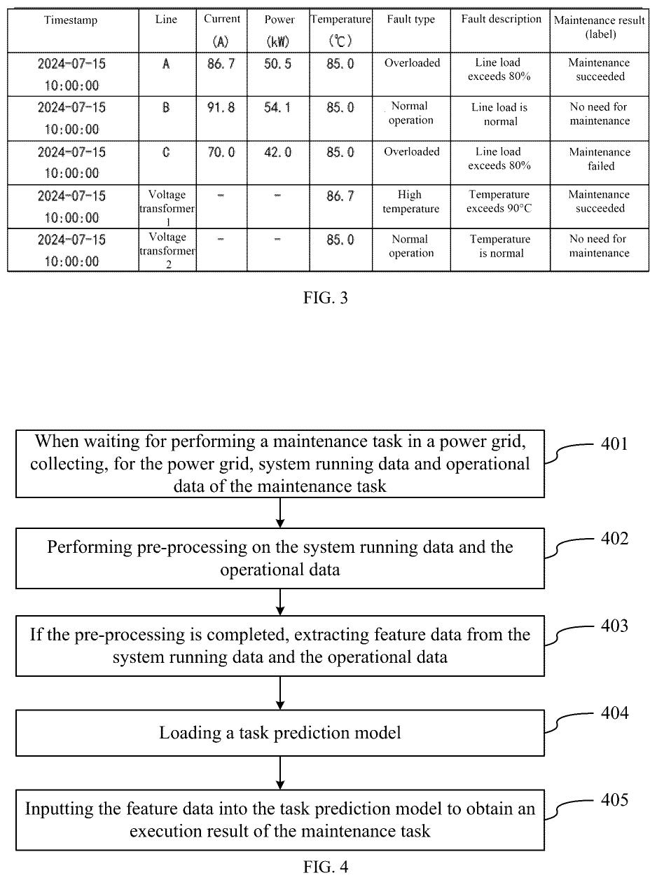

In this embodiment, as shown in FIG. 3, each row represents the system running data collected during simulation of devices on a certain line at a certain timestamp, recording the current, power, temperature, fault type, fault description, and maintenance result of this time for each device. The maintenance results obtained from simulation at respective timestamps are used as label data for training the deep learning model.

In this embodiment, the feature data is annotated with the label data based on a maintenance result of the simulation of the maintenance task, which can provide definite target information for subsequent analysis and model training. The annotation enables the machine learning algorithm to effectively learn the relationship between the input feature data, the model output results, and the label data, thereby improving the effectiveness of training the deep learning model.

A step 106, under supervision of the label data, training a preset deep learning model to be a task prediction model based on the feature data.

In this embodiment, by utilizing the annotated label data, the model is enabled to learn the complex relationship between the input feature data, model output results, and labeled data, thereby training the preset deep learning model to be the task prediction model.

In an embodiment of the present application, the step 106 may include following steps.

A step 1061, dividing the feature data into a training set and a testing set.

In this embodiment, the feature data is divided into the training set and the testing set in a ratio of 7:3. The training set is used to train the deep learning model and assist it in learning the relationship between the training set and the label data; the testing set is used to evaluate the performance of the deep learning models on unseen data, in order to test their predictive ability and robustness.

A step 1062, iteratively training the preset deep learning model based on the training set until the deep learning model meets a preset training condition.

Iterative training is a manner in machine learning and deep learning that optimizes parameters of a deep learning model by repeating the training process multiple times. Each iteration includes steps such as forward propagation to calculate predicted results, loss calculation, and backward propagation to update the parameters. This process is repeated until the performance of the deep learning model reaches the predetermined training condition.

In this embodiment, the training set is input into the preset deep learning model to perform the iterative training. By multiple times of iteration, the model can gradually learn the complex patterns and features from the training set and the label data. The training will not be stopped until the deep learning model meets the preset training condition.

The deep learning model may be a long short term memory (LSTM) network, a transformer (Transformer), etc., which will not be limited by the embodiments of the present application herein.

The long short term memory (LSTM) network is a special recurrent neural network (RNN), aimed at solving the gradient vanishing and exploding problems faced by traditional RNNs when processing long sequence data. LSTM effectively memorizes long-term dependent information by introducing gating mechanisms (input gate, forget gate, and output gate) to control the flow of information.

Transformer (Transformer) is a deep learning architecture based on self-attention mechanism. It can effectively capture the relationships among respective elements in the sequence by processing the input sequence in parallel, without relying on traditional recursive structures. Transformer is mainly composed of an encoder and a decoder. The encoder is responsible for extracting the input features, while the decoder generates the outputs.

In an embodiments of the present application, the step 1062 may further include following steps.

A step 110, inputting the training set into the deep learning model, to predict an execution result of a future maintenance task.

In this embodiment, the training set is input into an untrained deep learning model, to predict an execution result of a future maintenance task. This execution result is compared with the label data repeatedly, to optimize the parameters of the deep learning model, and assist in the training of the deep learning model.

A step 120, generating a loss value based on the predicted execution result and the label data.

In this embodiment, the loss value is generated based on the predicted execution result and the label data, to estimate the gap between the execution result predicted by the deep learning model and the actual label data. Through the loss value, the deep learning model can identify the accuracy of the current prediction, in order to adjust the parameter(s) during the training process to optimize the performance. The smaller the loss value, the more accurate the prediction of the deep learning model. Therefore, the loss value is an important indicator to guide the learning and improvement of the deep learning model.

A step 130, updating the deep learning model based on the loss value.

In this embodiment, by calculating the loss value, the deep learning model can identify which parameter needs to be adjusted, to reduce the gap between predicted values and true values. Based on the loss value, back propagation algorithms such as a stochastic gradient descent (SGD) algorithm or adaptive moment estimation (Adam) are used to update the deep learning model.

SGD algorithm is an optimization algorithm used to update the parameters of a model during the training process. Unlike traditional gradient descent algorithms, SGD only uses a small portion of training data (one or a few samples) to calculate gradients at a time, thereby accelerating training speed and improving adaptability to large datasets. This method helps to escape from a locally optimal solution and find a better global solution when facing complex non-convex optimization problems.

Adaptive moment estimation (Adam) is an optimization algorithm that improves the efficiency of gradient descent by combining a momentum method and an adaptive learning rate. It uses a first-order moment (mean value) and a second-order moment (variance) of a current gradient to adjust the learning rate of each parameter. It has strong adaptability and is particularly suitable for processing large-scale data and high-dimensional spaces.

A step 140, determining whether the deep learning model meets the preset training condition; if so, executing a step 150; if not, returning to executing the step 110.

In this embodiment, after completing a parameter update, the system checks whether the deep learning model reaches the set training criteria. These training criteria may include whether the reduction in the loss value is within an acceptable range, whether the performance of the deep learning model has significantly improved, or whether the number of training times has reached a predetermined upper limit. If it is detected these criteria are met, the system will confirm that the training process has been completed.

On the contrary, if these preset training conditions are not met, it means that the deep learning model has not yet achieved the desired learning effect. At this time, the system will return again to execute the inputting the training set into the deep learning model to predict the execution result of the future maintenance task. This cyclic design ensures that the deep learning model is continuously optimized and iterated, so that the output results of the deep learning model approach the label data, thereby improving the effectiveness and reliability of the deep learning model in a practical application.

A step 150, determining that the training of the deep learning model is completed.

In this embodiment, the deep learning model meets the preset training condition after multiple times of iterative training, and it is determined that the deep learning model has completed the training and can be used for the subsequent application of predicting the execution result of the maintenance task.

A step 1063, using the testing set to test the deep learning model, to generate a plurality of performance indicators.

In this embodiment, the divided testing set is used to test the trained deep learning model, to generate the plurality of performance indicators. The performance indicators refer to indicators, such as accuracy, precision, recall rate, of the deep learning model.

A step 1064, if the plurality of the performance indicators all conform a preset performance standard, deploying the deep learning model as the task prediction model.

In this embodiment, if the plurality of the performance indicators generated conform the preset performance standard, it indicates that the trained model performs well enough on unseen data. The deep learning model is deployed as the task prediction model to predict the execution result of performing the maintenance task on the power grid, in order to adjust the maintenance task and enhance the maintenance efficiency of the power grid.

In the embodiment of the present application, when a maintenance task is performed in a power grid, system running data and operational data of the maintenance task are collected for the power grid; a simulation of the maintenance task for the power grid is performed to expand the operational data under a variety of system running data; if the expanding is completed, pre-processing is performed on the system running data and the operational data; if the pre-processing is completed, feature data is extracted from the system running data and the operational data; the feature data is annotated with label data based on a maintenance result of the simulation of the maintenance task; and under supervision of the label data, a preset deep learning model is trained to be a task prediction model based on the feature data. Collecting and expanding operational data assists in gaining a more comprehensive understanding of the performance of maintenance tasks in the power grid under different operating conditions, thereby improving the generalization ability of the model. Secondly, the extraction of feature data and annotation of label data provide a high-quality training foundation for a deep learning model, enabling the model to predict the execution result of a future maintenance task more accurately and improving the efficiency of power grid maintenance.

### Second Embodiment

Referring to FIG. 4, it shows a flowchart of a maintenance task determination method provided in the second embodiment of the present application. The method can be executed by a maintenance task determination apparatus. The maintenance task determination apparatus may be implemented in the form of hardware and/or software, the maintenance task determination apparatus can be configured in a computer device. As shown in FIG. 4, the method includes:
a step 401, when waiting for performing a maintenance task in a power grid, collecting, for the power grid, system running data and operational data of the maintenance task.

In this embodiment, when waiting for performing the maintenance task in the power grid, the system running data and the operational data of the maintenance task are collected in real time for the power grid. The system running data and the operational data collected in real time are those that have not yet been maintained, and a maintenance result is still unknown.

A step 402, performing pre-processing on the system running data and the operational data.

In an embodiment of the present application, a linear interpolation method is used to fill in missing values for the system running data and the operational data; if the missing values are filled, a wavelet transform algorithm is used to remove noise from the system running data and the operational data; and if the noise is removed, Gaussian filtering processing is performed on the system running data and the operational data.

A step 403, if the pre-processing is completed, extracting feature data from the system running data and the operational data.

In an embodiment of the present application, a min-max scaling method is used to perform a normalization operation on the system running data and the operational data; and if the normalization operation is completed, a least absolute shrinkage and selection operator is used to extract the feature data from the system running data and the operational data.

A step 404, loading a task prediction model.

In this embodiment, the task prediction model after being trained by the above first embodiment is loaded, to analyze the collected system running data and operational data and predict an execution result of the maintenance task.

A step 405, inputting the feature data into the task prediction model to obtain an execution result of the maintenance task.

In this embodiment, feature data extraction is performed on the collected system running data and operational data; then the extracted feature data is input into the trained task prediction model, and the task prediction model outputs the execution result of this maintenance task, providing basis for decision-making, optimizing resource allocation, and improving the efficiency of maintaining power grid.

In the embodiments of the present application, when waiting for performing the maintenance task in the power grid, the system running data and the operational data of the maintenance task are collected for the power grid; the pre-processing is performed on the system running data and the operational data; if the pre-processing is completed, the feature data is extracted from the system running data and the operational data; the task prediction model is loaded; and the feature data is input into the task prediction model, to obtain the execution result of the maintenance task. By performing the pre-processing and the feature data extraction on the system running data and the operational data collected for the power grid, scientific basis can be provided for decision-making; the feature data is input into the trained task prediction model and the execution result of the maintenance task is obtained, thereby optimizing resource allocation, enhancing safety and reducing costs, and improving the efficiency of maintaining power grid.

An embodiment of the present application also provides a maintenance task determination method, including:
integrating power safety knowledge and power safety cases into power safety text information;
loading a feature extraction network obtained by the training method for the feature extraction network as described in the first aspect; the feature extraction network includes a transformer represented by a bidirectional encoder and a bidirectional long-short-term memory network;
inputting the power safety text information into the transformer represented by the bidirectional encoder to extract target semantic features;
inputting the target semantic features into the bidirectional long-short-term memory network for processing, to obtain power safety text features; and
matching the power safety cases based on the power text features.

### Third Embodiment

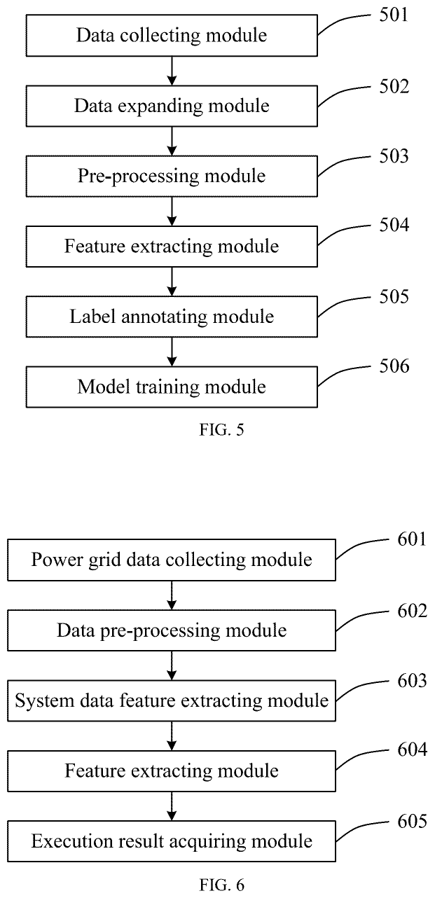

FIG. 5 is a schematic structure diagram of a task prediction model training apparatus provided in the third embodiment of the present application. As shown in FIG. 5, the apparatus includes:
a data collecting module 501, configured to: when a maintenance task is performed in a power grid, collect, for the power grid, system running data and operational data of the maintenance task;
a data expanding module 502, configured to: perform a simulation of the maintenance task for the power grid, to expand the operational data under a variety of the system running data;
a pre-processing module 503, configured to: if the expanding is completed, perform pre-processing on the system running data and the operational data;
a feature extracting module 504, configured to: if the pre-processing is completed, extract feature data from the system running data and the operational data;
a label annotating module 505, configured to: annotate the feature data with label data based on a maintenance result of the simulation of the maintenance task; and
a model training module 506, configured to: under supervision of the label data, train a preset deep learning model to be a task prediction model based on the feature data.

In an embodiment of the present application, the data expanding module 502 includes:
a rule formulating module, configured to: formulate one or more simulation rules for the power grid according to a knowledge graph of the maintenance task, where each of the one or more simulation rules comprises: a condition, a data source and operational steps;
a simulation performing module, configured to: call a preset rule engine to perform the simulation of the maintenance task for the power grid based on the one or more simulation rules, to obtain the operational data under a variety of the system running data; and
a data augmentation module, configured to: perform a data augmentation operation on the operational data, to expand the operational data.

In an embodiment of the present application, the simulation performing module includes:
a power grid simulation module, configured to: simulate running of the power grid in the preset rule engine to obtain the system running data, and load each of the one or more simulation rules; and
an operational data acquiring module, configured to: when it is detected, in the preset rule engine, that the system running data meets the condition, read target data from the system running data according to the data source, and perform an operation by substituting the target data into the operational steps, to obtain the operational data under a variety of the system running data.

In an embodiment of the present application, the pre-processing module 503 includes:
a missing value filling module, configured to: use a linear interpolation method to fill in missing values for the system running data and the operational data;
a noise removing module, configured to: if the missing values are filled, use a wavelet transform algorithm to remove noise from the system running data and the operational data; and
a data filtering module, configured to: if the noise is removed, perform Gaussian filtering processing on the system running data and the operational data.

In an embodiment of the present application, the feature extracting module 504 includes:
a data normalizing operation module, configured to: use a min-max scaling method to perform a normalization operation on the system running data and the operational data; and
a feature data extracting module, configured to: if the normalization operation is completed, use a least absolute shrinkage and selection operator to extract the feature data from the system running data and the operational data.

In an embodiment of the present application, the model training module 506 includes:
a data dividing module, configured to: divide the feature data into a training set and a testing set;
a deep learning model training module, configured to: iteratively train the preset deep learning model based on the training set until the deep learning model meets a preset training condition;
a model testing module, configured to: use the testing set to test the deep learning model, to generate a plurality of performance indicators; and
a performance standard conforming module, configured to: if the plurality of the performance indicators all conform a preset performance standard, deploy the deep learning model as the task prediction model.

In an embodiment, the deep learning model training module includes:
a data input module, configured to: input the training set into the deep learning model, to predict an execution result of a future maintenance task;
a loss value generating module, configured to: generate a loss value based on the predicted execution result and the label data;
a model updating module, configured to: update the deep learning model based on the loss value;
a training condition determining module, configured to: determine whether the deep learning model meets the preset training condition; if so, execute the method executed by a model training completion module; if not, return to execute the method executed by the data input module; and
the model training completion module, configured to: determine that the training of the deep learning model is completed.

The task prediction model training apparatus provided by the embodiments of the present application can execute the task prediction model training method provided by any embodiment of the present application, and has the corresponding functional modules and beneficial effects of executing the task prediction model training method.

### Fourth Embodiment

FIG. 6 is a schematic structure diagram of a maintenance task determination apparatus provided in the fourth embodiment of the present application. As shown in FIG. 6, the apparatus includes:
a power grid data collecting module 601, configured to: when waiting for performing a maintenance task in a power grid, collect, for the power grid, system running data and operational data of the maintenance task;
a data pre-processing module 602, configured to: perform pre-processing on the system running data and the operational data;
a system data feature extracting module 603, configured to: if the pre-processing is completed, extract feature data from the system running data and the operational data;
a model loading module 604, configured to: load the task prediction model trained by the task prediction model training method provided in the first aspect; and
an execution result acquiring module 605, configured to: input the feature data into the task prediction model, to obtain an execution result of the maintenance task.

In an embodiment of the present application, the data pre-processing module 602 includes:
a linear interpolation module, configured to: use a linear interpolation method to fill in missing values for the system running data and the operational data;
a wavelet transform module, configured to: if the missing values are filled, use a wavelet transform algorithm to remove noise from the system running data and the operational data; and
a Gaussian filtering module, configured to: if the noise is removed, perform Gaussian filtering processing on the system running data and the operational data.

In an embodiment of the present application, the system data feature extracting module 603 includes:
a normalizing module, configured to: use a min-max scaling method to perform a normalization operation on the system running data and the operational data; and
an extracting module, configured to: if the normalization operation is completed, use a least absolute shrinkage and selection operator to extract the feature data from the system running data and the operational data.

The maintenance task determination apparatus provided by the embodiments of the present application can execute the maintenance task determination method provided by any embodiment of the present application, and has the corresponding functional modules and beneficial effects of executing the maintenance task determination method.

### Fifth Embodiment

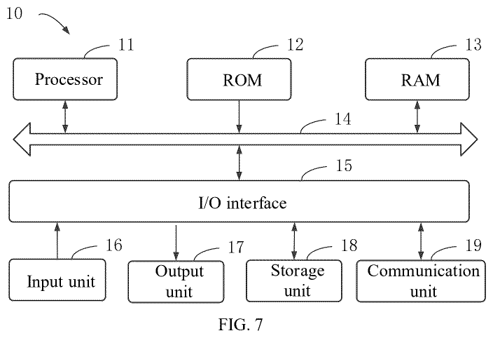

Referring to FIG. 7, it shows a schematic structure diagram of a computer device provided in the fifth embodiment of the present application. The computer device is intended to represent various forms of digital computers, such as laptops, desktop computers, work platforms, personal digital assistants, blade servers, mainframe computers, and other suitable computers. The computer device can also represent various forms of mobile apparatuses, such as personal digital assistant, cellular phones, smartphones, wearable devices (such as helmets, glasses, watches, etc.), and other similar computing apparatuses. The components, their connections and relationships, and their functions shown herein are only examples and are not intended to limit the implementation of the technical solutions described and/or required herein.

As shown in FIG. 7, the computer device 10 includes at least one processor 11, and a memory communicatively connected to the at least one processor 11, such as a read-only memory (ROM) 12, a random access memory (RAM) 13, etc. the memory stores a computer program executable by the at least one processor. The processor 11 can execute various suitable actions and processing according to the computer program which is stored in the read-only memory (ROM) 12 or loaded from a storage unit 18 to the random access memory (RAM) 13. In the RAM 13, various programs and data required by the operations of the computer device 10 can also be stored. The processor 11, ROM 12 and RAM 13 connect to each other through a bus 14. An input/output (I/O) interface 15 is also connected to the bus 14.

Multiple components in the computer device 10 connect to the I/O interface 15, including: an input unit 16, such as a keyboard, a mouse, etc.; an output unit 17, such as various types of displays, speakers, etc.; the storage unit 18, such as disks, optical discs, etc.; and a communication unit 19, such as network cards, modems, wireless communication transceivers, etc. The communication unit 19 allows the computer device 10 to exchange information/data with other devices through a computer network (such as the Internet) and/or various telecommunication networks.

The processor 11 may be various general-purpose and/or dedicated processing components with processing and computing capabilities. Some examples of the processor 11 include but are not limited to a central processing unit (CPU), a graphics processing unit (GPU), various dedicated artificial intelligence (AI) computing chips, various processors running machine learning model algorithms, digital signal processors (DSPs), and any appropriate processors, controllers, microcontrollers, etc. The processor 11 performs various methods and processing described above, such as the task prediction model training method, or, the maintenance task determination method.

In some embodiments, the task prediction model training method, or, the maintenance task determination method may be implemented as a computer program, which is tangibly included in a computer readable storage medium, for example, the storage unit 18. In some embodiments, part or all of the computer program can be loaded and/or installed on the computer device 10 via the ROM 12 and/or the communication unit 19. When the computer program is loaded to the RAM 13 and be executed by the processor 11, one or more steps of the task prediction model training method or the maintenance task determination method described above can be performed. In an embodiment, in other embodiments, the processor 11 can be, through any other appropriate means (for example, with the aid of firmware), configured to perform the task prediction model training method or the maintenance task determination method.

The various implementation methods of the system and technology described above herein may be implemented in digital electronic circuit systems, integrated circuit systems, field programmable gate arrays (FPGAs), application specific integrated circuits (ASICs), application specific standard products (ASSPs), systems of system-on-chip (SOC), complex programmable logic devices (CPLDs), computer hardware, firmware, and software, and/or their combinations. These various implementations may include: implemented in one or more computer programs, the one or more computer programs may be executed and/or interpreted on a programmable system including at least one programmable processor, where the programmable processor may be a dedicated or general-purpose programmable processor and can receive data and instructions from the storage system, at least one input apparatus, and at least one output apparatus, and transmit the data and instructions to the storage system, the at least one input apparatus, and the at least one output apparatus.

The computer program used to implement the method of the present application can be written using any combination of one or more programming languages. These computer program can be provided to processors of general-purpose computers, dedicated computers, or other programmable data processing apparatuses, enabling the functions/operations specified in flowcharts and/or block diagrams to be implemented when the computer program is executed by the processor. The computer program can be executed entirely on a machine, partially on a machine, partially on a machine and partially on a remote machine as independent software packages, or entirely on a remote machine or a server.

In the context of the present application, the computer readable storage medium may be a tangible medium that contains or stores a computer program for use by an instruction execution system, apparatus, or device, or use in combination with the instruction execution system, apparatus, or device. The computer readable storage medium may include, but are not limited to, electronic, magnetic, optical, electromagnetic, infrared, or semiconductor systems, apparatuses, or devices, or any suitable combination of the above. In an embodiment, the computer readable storage medium may be a machine readable signal medium. More specific examples of the machine readable storage medium includes an electrical connection based on one or more wires, a portable computer disk, a hard drive, a random access memory (RAM), a read-only memory (ROM), an erasable programmable read only memory (EPROM or flash memory), an optical fiber, a convenient compact disc read only memory (CD-ROM), an optical storage device, a magnetic storage device, or any suitable combination of the above.

In order to provide interaction with a user, the system and technology described herein can be implemented on the computer device. The computer device has: a display apparatus (e.g. CRT (cathode ray tube) or LCD (liquid crystal display) monitor) for displaying information to the user; and a keyboard and a pointing apparatus (such as a mouse or trackball), where the user can provide input to the computer device through the keyboard and the pointing apparatus. Other types of apparatuses can also be used to provide interaction with the user. For example, feedback provided to the user can be any form of sensory feedback (such as visual feedback, auditory feedback, or tactile feedback); and the input from the user can be received in any form (including sound input, speech input, or tactile input).

The system and technology described here can be implemented in a computing system that includes a backend component (such as a data server), or a computing system that includes a middleware component (such as an application server), or a computing system that includes a frontend component (such as a user computer with a graphical user interface or a web browser, through which the user can interact with the implementation of the system and technology described herein), or, a computing system that includes any combination of such backend component, middleware component or frontend component. The components of the system can be interconnected through any form or medium of digital data communication (such as a communication network). Examples of the communication network include a local area network (LAN), a wide area network (WAN), a blockchain network, and the Internet.

The computing system may include a client and a server. The client and the server are generally far apart from each other and typically interact with each other through a communication network. A relationship of the client and the server is generated by running computer programs that have a client-server relationship with each other on corresponding computers. The server may be a cloud server, also known as a cloud computing server or a cloud host, which is a host product in a cloud computing service system, to solve the defects of difficult management and weak business scalability in the traditional physical host and VPS services.

### Sixth Embodiment

An embodiment of the present application provides a computer program product, where the computer program product includes a computer program, when the computer program is executed by a processor, the task prediction model training method or the maintenance task determination method provided in any embodiment of the present application is implemented.

During the implementation of the computer program product, computer program codes for performing the operations of the present application can be written in one or more programming design languages or their combinations. The programming design languages include object-oriented programming languages such as Java, Smalltalk, and C++, as well as conventional procedural programming design languages, such as the “C” language or similar programming design languages. The program codes can be fully executed on a user's computer, partially executed on the user's computer, executed as an independent software package, partially executed on the user's computer and partially executed on a remote computer, or fully executed on a remote computer or server. In cases involving the remote computer, the remote computer can be connected to the user's computer through any kind of network—including the local area network (LAN) or the wide area network (WAN)—or, the remote computer can be connected to an external computer (for example, by using an Internet service provider to connect via the Internet).

It should be understood that various forms of procedures shown above can be used to reorder, add or delete a step. For example, various steps recorded in the present application can be executed in parallel, sequentially or in different sequences, as long as the expected result of the technical solution of the present application can be achieved, which are not limited herein.

The specific implementations mentioned above do not constitute a limitation on the scope of protection of the present application. Those skilled in the art should understand that various modifications, combinations, sub-combinations and substitutions can be made according to design requirements and other factors. Any modifications, equivalent substitutions and improvements made within the spirit and principles of the present application shall be included within the scope of protection of the present application.

What is claimed is:

1. A task prediction model training method, comprising:
when a maintenance task is performed in a power grid, collecting, for the power grid, system running data and operational data of the maintenance task;
performing a simulation of the maintenance task for the power grid, to expand the operational data under a variety of the system running data;
in a case the expanding is completed, performing pre-processing on the system running data and the operational data;
in a case the pre-processing is completed, extracting feature data from the system running data and the operational data;
annotating the feature data with label data based on a maintenance result of the simulation of the maintenance task; and
under supervision of the label data, training a preset deep learning model to be the task prediction model based on the feature data.

2. The method according to claim 1, wherein the performing the simulation of the maintenance task for the power grid, to expand the operational data under a variety of the system running data comprises:
formulating one or more simulation rules for the power grid according to a knowledge graph of the maintenance task, wherein each of the one or more simulation rules comprises: a condition, a data source and operational steps;
calling a preset rule engine to perform the simulation of the maintenance task for the power grid based on the one or more simulation rules, to obtain the operational data under a variety of the system running data; and
performing a data augmentation operation on the operational data, to expand the operational data.

3. The method according to claim 2, wherein the calling the preset rule engine to perform the simulation of the maintenance task for the power grid based on the one or more simulation rules, to obtain the operational data under a variety of the system running data comprises:
simulating running of the power grid in the preset rule engine to obtain the system running data, and loading each of the one or more simulation rules; and
when it is detected, in the preset rule engine, that the system running data meets the condition, reading target data from the system running data according to the data source, and performing an operation based on substituting the target data into the operational steps, to obtain the operational data under a variety of the system running data.

4. The method according to claim 1, wherein the performing pre-processing on the system running data and the operational data comprises:
using a linear interpolation method to fill in missing values for the system running data and the operational data;
in a case the missing values are filled, using a wavelet transform algorithm to remove noise from the system running data and the operational data; and
in a case the noise is removed, performing Gaussian filtering processing on the system running data and the operational data.

5. The method according to claim 1, wherein the extracting feature data from the system running data and the operational data comprises:
using a min-max scaling method to perform a normalization operation on the system running data and the operational data; and
in a case the normalization operation is completed, using a least absolute shrinkage and selection operator to extract the feature data from the system running data and the operational data.

6. The method according to claim 1, wherein the under supervision of the label data, training the preset deep learning model to be the task prediction model based on the feature data comprises:
dividing the feature data into a training set and a testing set;
iteratively training the preset deep learning model based on the training set until the deep learning model meets a preset training condition;
using the testing set to test the deep learning model, to generate a plurality of performance indicators; and
in a case the plurality of the performance indicators all conform a preset performance standard, deploying the deep learning model as the task prediction model.

7. The method according to claim 6, wherein the iteratively training the preset deep learning model based on the training set until the deep learning model meets the preset training condition comprises:
inputting the training set into the deep learning model, to predict an execution result of a future maintenance task;
generating a loss value based on the predicted execution result and the label data;
updating the deep learning model based on the loss value; and
determining whether the deep learning model meets the preset training condition; if so, determining the training of the deep learning model is completed; if not, returning to performing inputting the training set into the deep learning model, to obtain an execution result of a future maintenance task.

8. A maintenance task determination method, comprising:
when waiting for performing a maintenance task in a power grid, collecting, for the power grid, system running data and operational data of the maintenance task;
performing pre-processing on the system running data and the operational data;
in a case the pre-processing is completed, extracting feature data from the system running data and the operational data;
loading a task prediction model trained by following steps:
when a maintenance task is performed in a power grid, collecting, for the power grid, system running data and operational data of the maintenance task;
performing a simulation of the maintenance task for the power grid, to expand the operational data under a variety of the system running data;
in a case the expanding is completed, performing pre-processing on the system running data and the operational data;
in a case the pre-processing is completed, extracting feature data from the system running data and the operational data;
annotating the feature data with label data based on a maintenance result of the simulation of the maintenance task; and
under supervision of the label data, training a preset deep learning model to be the task prediction model based on the feature data; and
inputting the feature data into the task prediction model, to obtain an execution result of the maintenance task.

9. A computer device, comprising:
one or more processors;
a storage apparatus, configured to store one or more programs;
when the one or more programs are executed by the one or more processors, the one or more processors are caused to implement following steps:
when a maintenance task is performed in a power grid, collecting, for the power grid, system running data and operational data of the maintenance task;
performing a simulation of the maintenance task for the power grid, to expand the operational data under a variety of the system running data;
in a case the expanding is completed, performing pre-processing on the system running data and the operational data;
in a case the pre-processing is completed, extracting feature data from the system running data and the operational data;
annotating the feature data with label data based on a maintenance result of the simulation of the maintenance task; and
under supervision of the label data, training a preset deep learning model to be the task prediction model based on the feature data.

10. The computer device according to claim 9, wherein regarding the performing the simulation of the maintenance task for the power grid, to expand the operational data under a variety of the system running data, the one or more processors are caused to performing following steps:
formulating one or more simulation rules for the power grid according to a knowledge graph of the maintenance task, wherein each of the one or more simulation rules comprises: a condition, a data source and operational steps;
calling a preset rule engine to perform the simulation of the maintenance task for the power grid based on the one or more simulation rules, to obtain the operational data under a variety of the system running data; and
performing a data augmentation operation on the operational data, to expand the operational data.

11. The computer device according to claim 10, wherein regarding the calling the preset rule engine to perform the simulation of the maintenance task for the power grid based on the one or more simulation rules, to obtain the operational data under a variety of the system running data, the one or more processors are caused to performing following steps:
simulating running of the power grid in the preset rule engine to obtain the system running data, and loading each of the one or more simulation rules; and
when it is detected, in the preset rule engine, that the system running data meets the condition, reading target data from the system running data according to the data source, and performing an operation based on substituting the target data into the operational steps, to obtain the operational data under a variety of the system running data.

12. The computer device according to claim 9, wherein regarding the performing pre-processing on the system running data and the operational data, the one or more processors are caused to performing following steps:
using a linear interpolation method to fill in missing values for the system running data and the operational data;
in a case the missing values are filled, using a wavelet transform algorithm to remove noise from the system running data and the operational data; and
in a case the noise is removed, performing Gaussian filtering processing on the system running data and the operational data.

13. The computer device according to claim 9, wherein regarding the extracting feature data from the system running data and the operational data, the one or more processors are caused to performing following steps:
using a min-max scaling method to perform a normalization operation on the system running data and the operational data; and
in a case the normalization operation is completed, using a least absolute shrinkage and selection operator to extract the feature data from the system running data and the operational data.

14. The computer device according to claim 9, wherein regarding the under supervision of the label data, training the preset deep learning model to be the task prediction model based on the feature data, the one or more processors are caused to performing following steps:
dividing the feature data into a training set and a testing set;
iteratively training the preset deep learning model based on the training set until the deep learning model meets a preset training condition;
using the testing set to test the deep learning model, to generate a plurality of performance indicators; and
in a case the plurality of the performance indicators all conform a preset performance standard, deploying the deep learning model as the task prediction model.

15. The computer device according to claim 14, wherein regarding the iteratively training the preset deep learning model based on the training set until the deep learning model meets the preset training condition, the one or more processors are caused to performing following steps:
inputting the training set into the deep learning model, to predict an execution result of a future maintenance task;
generating a loss value based on the predicted execution result and the label data;
updating the deep learning model based on the loss value; and
determining whether the deep learning model meets the preset training condition; if so, determining the training of the deep learning model is completed; if not, returning to performing inputting the training set into the deep learning model, to obtain an execution result of a future maintenance task.

16. A computer device, comprising:
one or more processors;
a storage apparatus, configured to store one or more programs;
when the one or more programs are executed by the one or more processors, the one or more processors are caused to implement the maintenance task determination method according to claim 8.

17. A non-transitory computer readable storage medium, storing a computer program, wherein when the program is executed by a processor, the task prediction model training method according to claim 1 is implemented.

18. A non-transitory computer readable storage medium, storing a computer program, wherein when the program is executed by a processor, the maintenance task determination method according to claim 8 is implemented.
